(19) United States
(12) Patent Application Publication
(10) Pub. No.: US 2005/0194785 A1
(43) Pub. Date: Sep. 8, 2005

(54) Rain tight compression fitting coupling device

(76) Inventor: Sami Shemtov, Aventura, FL (US)

Correspondence Address: HOWARD C. MISKIN;C/O STOLL, MISKIN, & BADIE, THE EMPIRE STATE BUILDING, 350 FIFTH AVENUE SUITE 4710, NEW YORK, NY, 10118, US

(21) Appl. No.: 10/679,223

(22) Filed: Oct. 3, 2003

(51) Int. Cl. F16L 19/08

(52) U.S. Cl. 285/382.7

(57) ABSTRACT

A coupling device that provides a rain tight seal at the connection with a conduit includes a tubular casing, a nut, a compression ring and a sealing ring. Each of the tubular casing and nut has threading that correspondingly engages each other. The compression ring has a body with a U-shape cross section and substantially parallel fingers on opposite ends of the body that overlap to form a circular structure. The sealing ring is positioned either adjacent or nests concentrically within the compression ring. The sealing ring and compression ring are positioned between the tubular casing and the nut such that a rain tight seal is provided at the connection when the nut and tubular casing are tightly engaged.

### FIELD OF THE INVENTION

The invention relates to a device for coupling a pair of conduits containing electrical cables and/or wires. In particular, an improved device that provides a compression fitting around at least one of the conduit to be coupled to facilitate quick coupling of a conduit and provide a rain tight seal around the conduit.

### BACKGROUND OF THE INVENTION

Coupling devices are commonly used to connect two or more conduits containing electrical cables and/or wires. Prior art coupling devices for a pair of conduits are generally tubular, with threaded opposite ends for receiving the conduit. Many prior art devices have sought to prevent rain water or other ground water from entering the conduit and creating electrical and corrosion problems. However, such prior art coupling devices allow moisture or rain to eventually seep through the threading past the seal, causing corrosion or short-circuit of the electrical cables and/or wires.

Therefore, there is a need for a coupling device that effectively provides a rain tight seal around a conduit and facilitates quick coupling of a conduit.

### SUMMARY OF THE INVENTION

The present invention provides a coupling device for conduits that provides a rain tight seal around the conduits.

The coupling device of the present invention comprises a tubular casing, a nut, a compression ring and a sealing washer. At least one end of the tubular casing has external threading that corresponds to the internal threading of the nut. The compression ring has a body with a U-shape cross-section and fingers on opposite ends of the body that overlap to form a circular structure. The compression ring preferably rests within the nut, and as shown, in an enlarged bulge portion of the nut. The sealing washer is located either adjacent to or nests concentrically within the compression ring.

In one embodiment of the invention, an additional friction washer is used. The internal wall of the tubular casing adjacent its threaded end is tapered. A sealing washer shown has a triangular transverse cross section and has at least one flat end and an outer tapered surface and a tubular inner surface with a uniform radius. The sealing washer's tapered surface mates correspondingly with the mating tapered internal wall of the tubular casing. A friction washer having a reverse triangular transverse cross section abuts the sealing washer. The friction washer has at least one flat end and an inner tapered surface and a tubular outer surface with a uniform radius. The flat end of the sealing washer abuts the flat end of the friction washer. The compression ring correspondingly abuts the inner tapered surface of the friction ring when the nut is threaded onto the tubular casing with the compression ring nesting within the bulge portion of the nut. When a conduit is axially placed into the tubular casing and the nut is threadedly tightened onto the tubular casing, the compression ring is pushed against the friction washer, which then forces the sealing washer against the tubular casing in a water sealing relationship to provide a rain tight seal at the connection.

In another embodiment of the invention, the sealing washer has an outer surface with a uniform radius and a convexly curved inner surface. The sealing washer is located concentrically within the U-shape compression ring. When a conduit is axially placed into the tubular casing, the threadedly tightening of the nut onto the tubular casing forces the compression ring against the tubular casing to provide a rain tight seal at the connection.

### BRIEF DESCRIPTION OF THE DRAWINGS

A preferred embodiment of the present invention has been chosen for purposes of illustration and description and is shown in the accompanying drawings forming a part of the specification wherein:

FIG. 1 is an exploded view of a first embodiment of the rain tight compression fitting coupling device of the present invention.

FIG. 2 is a perspective view of the assembled first embodiment of the present invention.

FIG. 3 is a cross section view of the first embodiment of the present invention taken from line 3-3 of FIG. 2.

FIG. 4 is an exploded view of a second embodiment of the rain tight compression fitting coupling device of the present invention.

FIG. 5 is a perspective view of the assembled second embodiment of the present invention.

FIG. 6 is a cross section view of the second embodiment of the present invention taken from line 6-6 of FIG. 5.

### DETAILED DESCRIPTION OF THE PREFERRED EMBODIMENTS

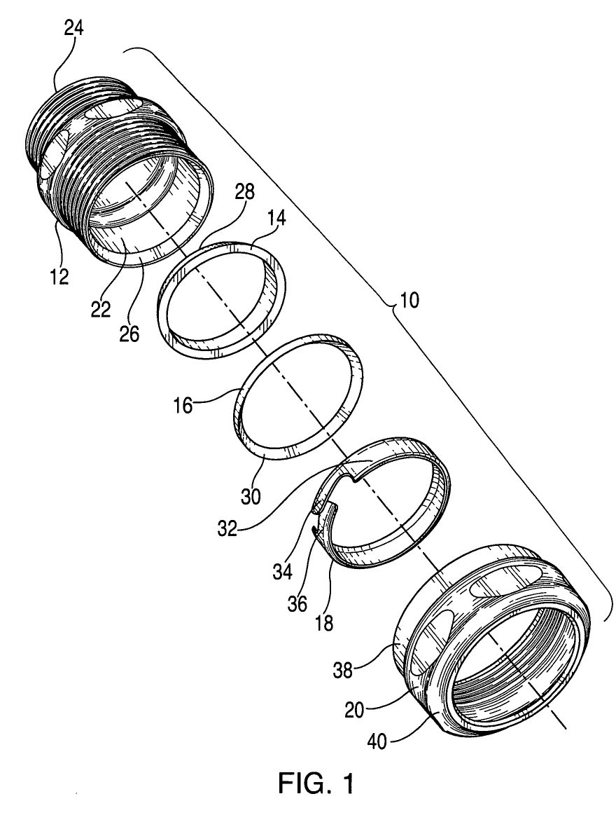

With reference to the drawings, wherein the same reference number indicates the same element throughout, there is shown in FIG. 1 an exploded view of a rain tight compression fitting coupling device 10 of the present invention. As shown in FIG. 1, the coupling device 10 includes a tubular casing 12, a sealing washer 14, a friction washer 16, a compression ring 18 and a nut 20.

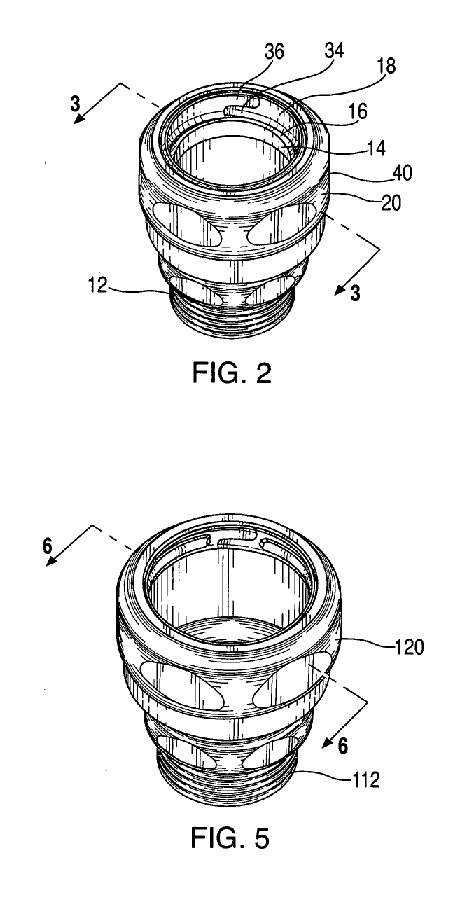

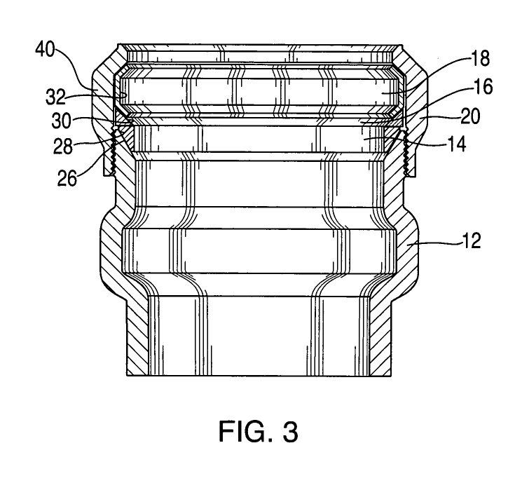

As shown in FIGS. 1-3, tubular casing 12 has two externally threaded ends 22 and 24. At least one end 22 of tubular casing 12 has a tapered internal wall 26.

Sealing washer 14 has a right-triangular transverse cross section with a tapered outer surface 28 that correspondingly mates with the internal wall 26 of tubular casing 12. Sealing washer 14 has an inner surface having a uniform radius from its axial center. Sealing washer 14 is preferably made of a rubber or plastic material.

Friction washer 16 has a reverse right-triangular transverse cross section with a tapered inner surface 30. Friction washer 16 has an outer surface having a uniform radius from its axial center. Friction washer 16 is preferably made of an aluminum or rust-proof metal. The flat ends of sealing washer 14 and friction washer 16 abut each other. The sealing washer 14 and friction washer 16 may be attached together by an adhesive means known to one skill in the art.

Compression ring 18 has a body 32 with a U-shape cross section and fingers 34 and 36 moveable towards and away from each other at opposite ends. Fingers 34 and 36 extend substantially parallel to each other moveable toward and away from each other to form the circular ring structure of compression ring 18. When ring is compressed, fingers 34 and 36 move toward each other. The tapered section of compression ring 18 correspondingly mates with the tapered inner surface 30 of friction washer 16.

Nut 20 is internally threaded at one end 38 to correspondingly engages with the external threading 22 of the tubular casing 12 and has an enlarged bulge portion 40 adjacent the other end. Compression ring 18 concentrically nests within the bulge portion 40. When a conduit is axially placed into the tubular casing 12, the threadedly tightening of the nut 20 against tubular casing 12 pushes the compression ring 18 against the friction washer 16, which then pushes the sealing washer 14 against the tubular casing 12 to provide a rain tight seal at the connection.

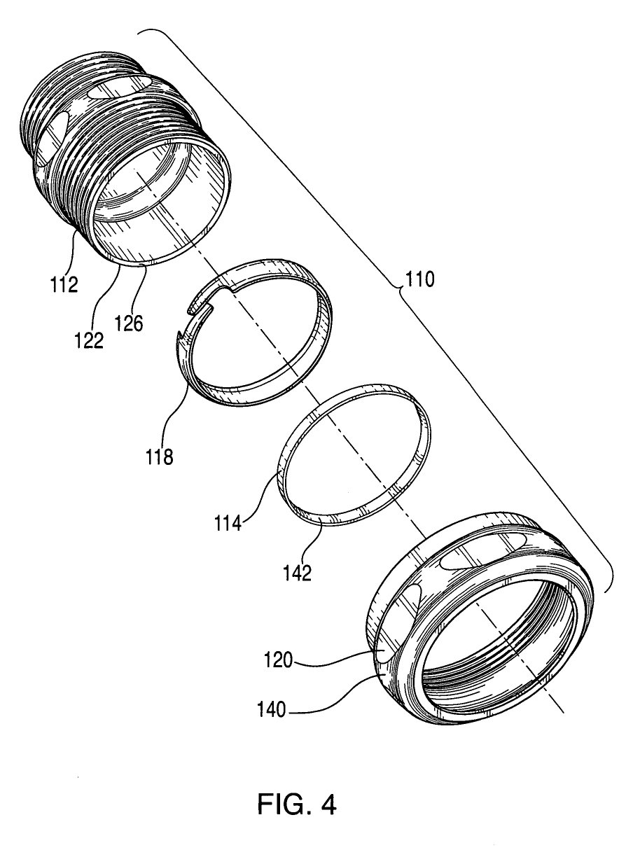

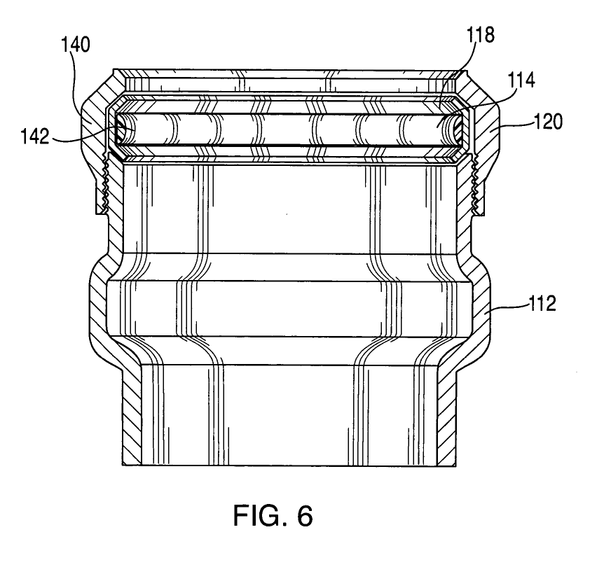

A second embodiment of the rain tight compression fitting coupling device 110 is shown in FIGS. 4-6. As shown in FIG. 4, the coupling device 110 includes a tubular casing 112, a sealing washer 114, a compression ring 118 and a nut 120. Tubular casing 112, compressing ring 118 and nut 120 are identical to the tubular casing 12, compression ring 18 and nut 20 of the first embodiment shown in FIGS. 1-3. One end 122 of tubular casing 112 has a slightly tapered wall 126. Components of the second embodiment 110 which correspond to components of the first embodiment 10 have reference numbers with 100 added to them.

The sealing washer 114 has an outer surface with a uniform radius from the axial center and a convexly curved inner surface 142. Sealing washer 114 nests concentrically within the compression ring 118, which then nests concentrically within the bulge portion 140. When a conduit is axially placed into the tubular casing 112, the threadedly tightening of the nut 120 against tubular casing 112 pushes the compressing ring 18 against the slightly tapered wall 126 and the sealing washer 114 provides a rain tight seal at the connection.

The features of the invention illustrated and described herein are the preferred embodiments. Therefore, it is understood that the appended claims are intended to cover unforeseeable embodiments with insubstantial differences that are within the spirit of the claims.

1. A device for rain tight coupling of contiguous conduits, comprising:
a tubular casing having opposite ends with a fastening means at one end;
a sealing washer positioned adjacent said one end of said tubular casing;
a compression ring having a body with a U-shape cross section and substantially parallel fingers extending from opposite ends of said body to form a circular structure, said fingers moveable toward each other in response to said ring being compressed, said compression ring positioned adjacent said sealing washer; and
a nut having fastening means that correspondingly engages said fastening means of said tubular casing, wherein said sealing washer and said compression ring are positioned adjacent and between said tubular casing and said nut to provide a rain tight seal in response to tightly engaging said fastening means of said tubular casing with said fastening means of said nut to compress said compression ring.

2. The device of claim 1 wherein said fastening means of said tubular casing comprises external threading and said fastening means of said nut comprises internal threading.

3. The device of claim 1 wherein said nut further having a body with an enlarged bulge portion and said compression ring nests concentrically within said enlarged bulge portion.

4. The device of claim 1 wherein said tubular casing further having a tapered internal wall at said one end.

5. The device of claim 4 further comprises a friction washer positioned between said sealing washer and said compression ring.

6. The device of claim 5 wherein said sealing washer having an outer tapered surface and a tubular inner surface with a uniform radius and a flat end, said outer tapered surface of said sealing washer correspondingly mates with said tapered internal wall of said tubular casing.

7. The device of claim 6 wherein said friction washer having an inner tapered surface and a tubular outer surface with a uniform radius and a flat end that abuts said flat end of said sealing washer.

8. The device of claim 7 further comprises means for adhering said flat end of said friction washer with said flat end of said sealing washer.

9. The device of claim 7 wherein said U-shape body of said compression ring having an outer surface that correspondingly mates with said inner tapered surface of said friction washer.

10. The device of claim 4 wherein said sealing washer having an outer surface with a uniform radius and a convexly curved inner surface.

11. The device of claim 10 wherein said sealing washer nests concentrically within said compression ring.

12. The device of claim 11 wherein said nut further having a body with an enlarged bulge portion and said compression ring nests concentrically within said enlarged bulge portion.

15. The device of claim 1 wherein said sealing washer is made of a rubber material.

16. The device of claim 1 wherein said sealing washer is made of a plastic material.

17. The device of claim 1 wherein said tubular casing is made of a rust-proof metal.

18. The device of claim 1 wherein said compression ring is made of a rust-proof metal.

19. The device of claim 1 wherein said nut is made of a rust-proof metal.

20. The device of claim 5 wherein said friction washer is made of a rust-proof metal.
